(19) United States
(12) Patent Application Publication
(10) Pub. No.: US 2020/0398297 A1
(43) Pub. Date: Dec. 24, 2020

(54) Method for conveying a working medium

(71) Applicant: EISENMANN LACTEC GMBH, Rodgau (DE)

(72) Inventors: Burkhard BILZ, Goldbach (DE); Akyildiz SEYHAN, Seligenstadt (DE); Stefan POHL, Rodgau (DE); Carsten BERBERICH, Leidersbach (DE)

(73) Assignee: Eisenmann LacTec GmbH, Rodgau (DE)

(21) Appl. No.: 16/643,634

(22) PCT Filed: Aug. 22, 2018
(86) PCT No.: PCT/EP2018/072685

§ 371 Date: Mar. 2, 2020

(30) Foreign Application Priority Data
Sep. 1, 2017 (DE) 10 2017 120 213.7

(51) Int. Cl. B05B 12/14; B65G 53/30

(52) U.S. Cl. CPC B05B 12/1481; B65G 2201/0291; B65G 53/30

(57) ABSTRACT

A method for conveying a working medium within a supply line (2), wherein a pig package (48) is moved into the supply line (2) by means of a pushing medium conveyed by a first pump (40) to a proximal end of the supply line (2), is intended to enable TPS operation in a manner that is as technically simple as possible. To this end, a first conveying quantity of the pushing medium is determined by means of a first flow-measuring cell (44) associated with the proximal end, wherein a position of the pig package (48) in the supply line (2) is determined from the first conveying quantity and information about the cross-section of the supply line (2).

The invention relates to a method for conveying a working medium within a supply line, wherein a pig package is moved into the supply line by means of a pushing medium conveyed by a first pump to a proximal end of the supply line. It further relates to a system comprising a supply line, a first pump, associated with a proximal end of the supply line, for a pushing medium for moving a pig package into the supply line.

Such processes and systems are used, for example, to convey paint within hoses as supply lines. Such supply lines exist, for example, in a coating plant, in particular a painting plant, in which a paint reservoir is connected to a gun unit in a manner known per se. The pig is an approximately circular-cylindrical object, waisted in the middle, which tightly fills the cross-section of the line and is pressed through the supply line by means of a pushing medium and pushes the medium to be pressed out in front of it. Within the scope of the pigging technique, in addition to the pig, sluices (so-called “pig stations”) are also required which are built into the system and through which the pig can be inserted into and removed from the lines or temporarily remain without movement.

Such a pig can also be used when cleaning corresponding supply lines with a suitable cleaning agent. A pig is also frequently used to serve as a separator between two fluid working media. Between two pigs a certain paint volume can be transported in the manner of a package. In the context of the present application, the term pig package is understood to mean a single pig or a package of several pigs, possibly with a working medium introduced in between.

Thus, the working medium mentioned above can for example be paint or a cleaning agent, which is present on one side of the pig within the supply line. Compressed air is usually used as the pushing medium, which is applied to the pig on the other side. However, a liquid medium can also serve as pushing medium.

The pigging technique makes it possible to use different types and colors of paint within a supply line, which are each introduced from a paint reservoir into the supply line via lateral, valve-controlled feed lines or are removed accordingly for feeding to the application unit. In painting plants, different colors can thus be used in quick succession in series production operation. Often the so-called paint recovery technique is used here, i.e. the supply line is filled with the corresponding paint color and after completion of the painting process the paint quantity still in the supply line is returned to the corresponding paint reservoir by means of the pigging technique described.

If, however, less frequently used special colors or so-called tie colors that are only used once are to be used, the so-called TPS (tracking paint supply) procedure is often applied. In a TPS system, only the amount of paint required at the points of consumption to be supplied is filled into the supply line (with a certain reserve). After filling with this quantity, a pig is sent after this paint quantity. It is preferably pressurized with compressed air and pushes the paint quantity to the points of consumption, even over longer distances. After the workpiece has been painted at the last point of consumption, the paint quantity in the supply line is used up, except for a minimal remainder. Depending on the quantity or usability, it can either be returned to the storage container or disposed of. Afterwards the line is flushed.

With TPS systems it is necessary to know the exact position of the pigs or the pig package, because the small amount of paint has to be precisely directed to the points of consumption (tracking). For this purpose, the pigs may be provided with e.g. permanent magnets or other markers, and appropriate measuring devices must be available on the supply line. In addition, it must be possible to determine the paint quantity precisely, so that appropriate measuring cells must be used, which must be designed for paint as a measuring medium and must be cleaned during operation.

It is therefore the object of the invention to specify a method and a system of the type mentioned above, which allows TPS operation in the technically simplest possible manner.

With regard to the method, this task, according to the invention, is solved by determining a first conveying quantity of the pushing medium by means of a first flow-measuring cell assigned to the proximal end, and wherein a position of the pig package in the supply line is determined from the first conveying quantity and information about the cross-section of the supply line.

With regard to the system, the task is solved by the system further comprising a flow-measuring cell assigned to the proximal end, designed to determine a first conveying quantity of the pushing medium, and a control device designed to determine a position of the pig package in the supply line from the first conveying quantity and information about the cross-section of the supply line.

The invention is based on the consideration that a TPS operation, especially in paint supply systems for common, frequently used paints, would be possible in a technically particularly simple way, if an exact determination of the position of the pig packages could be achieved without costly additional measures. It was hereby recognized that a position determination of the pig packages could not only be done directly via e.g. magnetic systems, but would take place indirectly. For this purpose, a measurement related to the pushing medium driving the pig should be used. The volume of the pushing medium can namely be measured by means of flow-measuring cells e.g. in the area of the pump or at the inlet of the supply line. As the cross-section or cross-sectional profile of the supply line is known or can be measured beforehand, it is possible to indirectly infer the position of the pig package from the flow rate without having to install additional measuring devices in the supply line itself.

In an advantageous embodiment of the method, a targeted change in position of the pig package is effected by controlling the first pump. With regard to the system, the control device is advantageously further designed to effect a specific change in position of the pig package by controlling the first pump. The measurement of the position is therefore not only used passively as a source of information, but actively in the manner of a regulation/control: A setpoint value is given for the position of the pig package, from the difference between the current position and the target position of the pig package a quantity of pushing medium is determined, which has to be introduced into the supply line for this purpose, and then the corresponding quantity is introduced into the supply line so that the pig package reaches the target position.

In a further advantageous embodiment of the method, the pig package consists of at least two pigs, whereby the working medium is introduced into the interspace between the two pigs or discharged from it by means of a feed line opening into the interspace between the two pigs and arranged on the supply line, wherein the supply line is filled with pushing medium on both sides of the pig package, wherein a second conveying quantity of the pushing medium is determined by means of a second flow-measuring cell assigned to a distal end of the supply line, and wherein a volume of the working medium introduced into the interspace or discharged therefrom is determined from the first and second conveying quantity and information about the cross-section of the supply line. With regard to the system, the pig package advantageously consists of at least two pigs, wherein the supply line has a feed line for introducing or discharging the working medium into the interspace between the two pigs, wherein the supply line is filled with pushing medium on both sides of the pig package, further comprising a second flow-measuring cell assigned to the distal end, designed for determining a second conveying quantity of the pushing medium, wherein the control device is further designed to determine a volume of the working medium introduced into the interspace or discharged therefrom from the first and second conveying quantity and information about the cross-section of the supply line.

Specifically, if a pig package consists of two pigs, paint can be conveyed in the space between the two pigs. If the first pig is positioned by means of the method just described in such a way that a feed line arranged on the supply line opens into the space between the pigs and paint is introduced via the feed line, the paint then serves as a kind of pushing medium for the second pig of the pig package and pushes it further. If the rear space of the second pig is filled with pushing medium, the position of the second pig and thus, in connection with the position of the first pig, the volume of the paint introduced into the interspace can be inferred from the cross-sectional profile of the supply line by means of a flow-measuring cell at the distal end of the supply line, as described above, without directly measuring this paint quantity. Here, too, the paint pump of the feed line can be controlled advantageously using this volume information.

In a further advantageous embodiment of the method, a second pump is used to convey pushing medium into the distal end of the supply line. With regard to the system, it advantageously includes a second pump associated with the distal end of the supply line, for conveying pushing medium into the distal end of the supply line. In this way, a symmetry of the entire arrangement is achieved, which allows the position to be changed and measured in any direction.

Also with regard to the distal end of the supply line, in a preferred embodiment of the method a specific change of position of the pig package is effected by controlling the second pump. With regard to the system, the control device is further designed to effect a targeted change in position of the pig package by controlling the second pump. Thus, here too, active control/regulation of the positioning—as described above with regard to the first pump—is therefore advantageously carried out.

In another advantageous embodiment of the method, the position of the pig package is changed by controlling the first and/or the second pump in such a way that the feed line opens into the interspace. With regard to the system, the control device is advantageously further designed to cause a change in position of the pig package by controlling the first and/or the second pump in such a way that the feed line opens into the interspace. The provided indirect position determination and influencing by flow-measuring cells and pumps for the pushing medium on both sides of the supply line is therefore used to move the pig package or the paint-carrying interspace specifically to feed lines, to receive paint or to deliver it to consumption stations.

In an advantageous embodiment of the method, the position of the pig package is changed with variable speed. With respect to the system, it advantageously comprises a flow control device, associated with the proximal and/or distal end of the supply line, for the pushing medium to vary the speed of the position change. Variable speed control enables particularly precise control of the positional fine-tuning of the pig package in the area of a feed line, while the speed can be increased on long transport distances between individual positions. Since the speed of the pig package depends on the inlet pressure and pressure loss in the region of the supply line filled with pushing medium, appropriate components which change the mentioned sizes are suitable for this purpose. These are, for example, proportional valves or variable orifices which are controlled accordingly by the control device to change the speed. A change in the speed of the respective pump would also be suitable for changing the speed; in this case the pump itself (designed for variable speed setting) would be a flow control device in the above sense.

Although the method and the system described can be used for any working medium in general, the working medium is advantageously a coating agent, especially paint.

A control device for a system for conveying a working medium within a supply line is advantageously designed to carry out the described method. On the basis of the above description, it will be clear to the person skilled in the art how it is to be carried out, namely by means of suitable data-side control connections to pumps and measuring cells, a memory for storing the volume profile of the supply line and a processor on which appropriate software for carrying out the process runs.

The advantages achieved with the invention consist in particular in the fact that by indirectly measuring and controlling the position of the pigs of a pig package by means of a flow measurement of the pushing medium, both the position of the package and the volume of the working medium transported in the package are known and can be influenced. This enables one to measure paint to the exact milliliter without measuring cells in the paint which would require flushing. Low wear is achieved.

In particular, by means of the system, normal supply lines not equipped with magnetic measuring devices can be retrofitted for the TPS operation described above. With the same system, the TPS method as well as a conventional paint supply with paint recovery can be used. Maximum flexibility is achieved in a uniform system and paint loss from the supply to the application can be reduced to an absolute minimum.

The described system is also suitable for individual materials in a multi-component system, independent of the specific paint system. This applies to both aqueous and solvent-based systems. In a polyurethane paint system, for example, the system can be used for the A component and separately for the B component (isocyanate).

An exemplary embodiment of the invention is explained in more detail by means of drawings. They show:

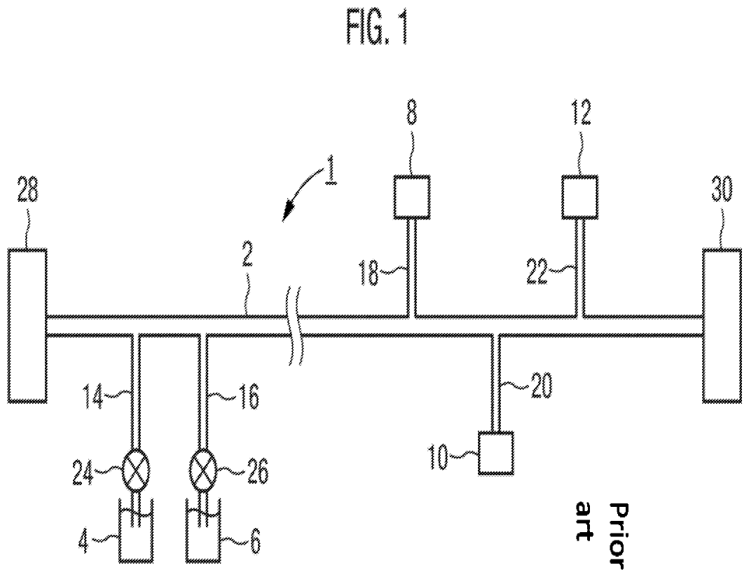

FIG. 1 a schematic diagram of a system with a supply line for paint according to the prior art, and

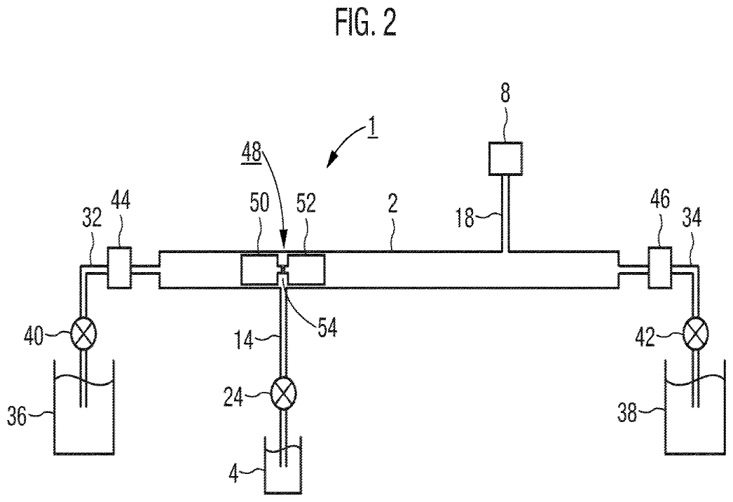

FIGS. 2 to 5 steps of a method for conveying paint through the supply line.

Identical parts are marked with the same reference signs in all drawings.

FIG. 1 shows a schematic diagram of a known system 1 with a supply line 2 for conveying a working medium, which in the exemplary embodiments described here is paint. Such a system 1 is used, for example, in a painting plant. It connects various paint reservoirs 4, 6 of different paint colors with points of consumption 8, 10, 12, each of which comprise an applicator for paint. Paint reservoirs 4, 6 as well as points of consumption 8, 10, 12 are each connected to the inside of the supply line via a feed line 14, 16, 18, 20, 22. In the feed lines 14, 16 in FIG. 1, pumps 24, 26 are shown for conveying the paint from the paint reservoir 4, 6. In principle, all feed lines 14, 16, 18, 20, 22 can contain such pumps or valves to shut off the feed line 14, 16, 18, 20, 22; however, these are not shown in FIG. 1.

The transport of the different coating agents or paints through the supply line 2 and the separation of different paints as well as of paint and pushing medium is done by means of pigs not shown in FIG. 1. A pig is an approximately circular-cylindrical object, waisted in the middle, which tightly fills the cross-section of the line and is pressed through the supply line 2 by means of a pushing medium and pushes the medium to be pushed out in front of it. For this purpose, system 1 has pig stations 28, 30 at the beginning and end of the supply line, which serve as sluices through which the pig can be inserted and removed from supply line 2.

The system 1 shown in FIG. 1 is designed for the paint recovery technique suitable for frequently used paints. For this purpose, the supply line 2 is filled with the corresponding paint from one of the paint reservoirs 4, 6, and after completion of the painting process, the paint quantity still in the supply line 2 is returned to the corresponding paint reservoir 4, 6 by means of the pigging technique described. The pushing medium used in the exemplary embodiments is a liquid cleaning agent, which is applied to the pig on the other side.

If, however, less frequently used special colors are to be used, the TPS process (tracking paint supply) should be applied for this purpose, in which only the exact amount of paint is filled in as is required at the points of consumption 8, 10, 12 to be supplied. The upgrading of system 1 for the TPS method and the implementation of the method is shown in FIGS. 2 to 5.

FIG. 2 shows the correspondingly modified system 1, although for reasons of clarity the pig stations 28, 30 are not shown. In addition, only one paint reservoir 4 with pump 24 and feed line 14 and a point of consumption 8 with feed line 18 is shown in each case, although there are actually several in each case, as described for FIG. 1.

The supply line 2 has at both ends a symmetrically designed pushing medium feed line 32, 34, which leads from a pushing medium reservoir 36, 38 into the respective end of the supply line 2. Each of the pushing medium feed lines 32, 34 has a pump 40, 42 and a flow-measuring cell 44, 46, which measures the volume flow, i.e. the volume of pushing medium flowing through per time unit. The pumps 40, 42 and flow-measuring cells 44, 46 are connected on the data side to a control device, not shown in detail, which analyzes the information from the flow-measuring cells 44, 46 and controls the pumps 40, 42. The control unit also stores precise information about the cross-sectional profile of the pushing medium feed lines 32, 34 and the supply line 2.

In the first step of the method shown in FIG. 2, a pig package 48, consisting of two pigs 50, 52 in contact with each other, is moved into the supply line 2. At least one of the pigs 50, 52 has a protrusion on the side facing the other pig 50, 52, so that a gap 54 remains between them. In the exemplary embodiment shown here both pigs 50, 52 have such protrusions. The position of the pig package 48 is determined and changed indirectly via the measurements in the flow-measuring cells 44, 46. Since the exact volume of pushing medium introduced into or discharged from the supply line 2 by means of the pumps 40, 42 can be determined and, in addition, the cross-sectional profile of the pushing medium feed lines 32, 34 and the supply line 2 is known, the control device can determine the exact longitudinal extension of the pushing medium column on both sides of the pig package 48 and from this the position of the pig package 48. Accordingly, the control unit can also control the pumps 40, 42 accordingly to achieve a targeted change of position.

This change in position is effected by the force of the pushing medium acting on one side of the pig package 48. By means of the force exerted, said package is moved, wherein the sealing element of each pig 50, 52 provides a contact surface for the pushing medium. Thus, on the one side of the pig package 48, the pushing medium exerts a force on the contact surface of the sealing element provided there, whereby as a result of the forces exerted on its contact surfaces, it is pressed against the inner wall of the supply line 2. The sealing elements of the pigs 50, 52 are thereby dimensioned in such a way that they already lie sealingly against the inner wall of the supply line 2, even if the pig 50, 52 is not moved in it. When the pig is driven inside the supply line 2, the sealing elements move along the inner wall of the supply line 2, by means of which liquid medium adhering to the inner wall is drawn off and pushed in front of the pig 50, 52 in the direction of movement of the pig.

By appropriately controlling the pumps 40, 42, the pig package 48 in the supply line 2 is displaced in the step shown in FIG. 2 such that the interspace 54 is arranged in such a way that the feed line 14 leads from the paint reservoir 4 into the interspace 54.

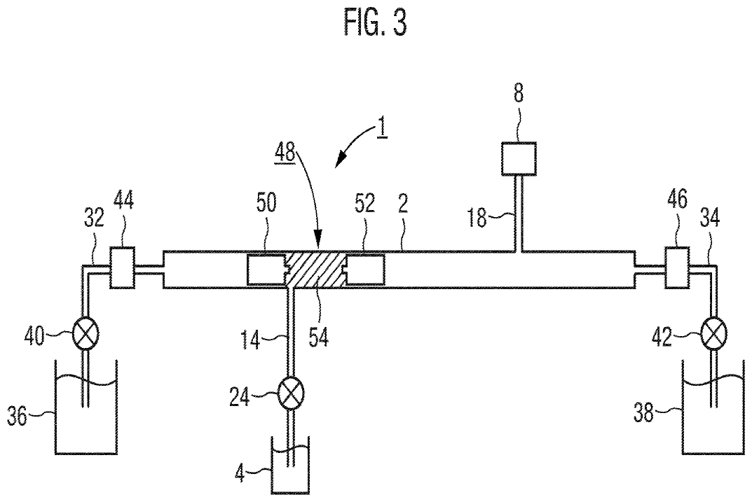

In the next step, shown in FIG. 3, the control unit controls the pump 24 for the paint from the paint reservoir 4. The pig 50 is thereby kept in a constant position by the corresponding closing the supply line 2 on the left side of FIG. 3, for example by a valve not shown in detail. By conveying paint through the pump 24 into the interspace 54, a force is exerted on the pig 52 on the right side in FIG. 3, so that it is pushed further along in the supply line 2 and pushing medium is supplied into the pushing medium reservoir 38. The exact quantity of the displaced pushing medium is recorded in the flow-measuring cell 46. It corresponds exactly to the quantity of paint introduced into the interspace 54, so that the control device—again indirectly—knows exactly the quantity of paint introduced and stops the paint supply by means of the pump 24, as soon as a sufficient quantity of paint is contained in the interspace 54.

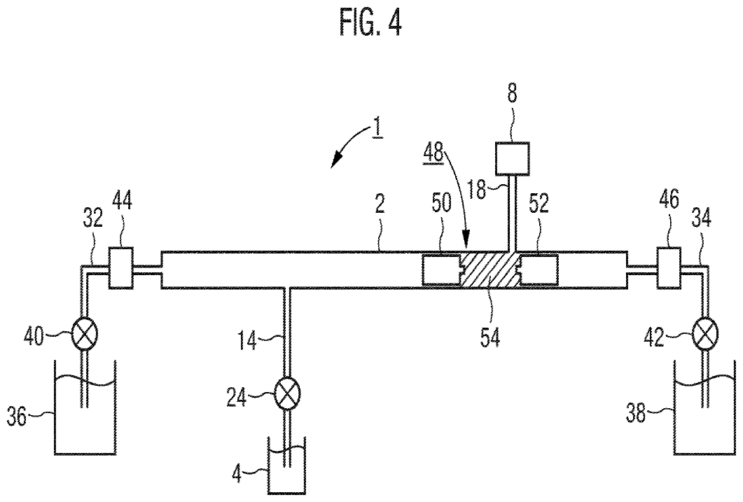

In the next step, shown in FIG. 4, the pig package 48, which now transports the defined quantity of paint in its interspace 54 between the pigs 50, 52, is moved on in the feed line 2 by controlling the pumps 40, 42 while monitoring the position by means of the flow-measuring devices 44, 46, until the interspace 54 containing the paint is positioned in such a way that the feed line 28 to the point of consumption 8 opens into the interspace 54. The pumps 40, 42 are hereby designed in such a way that their speed is variable. They are therefore also suitable for variably controlling the flow of pushing medium. In the exemplary embodiment, this is used to accelerate the speed of the pig package 48 during transport to the target position on the feed line 28. In the vicinity of the feed line 28, the speed of movement is reduced for fine adjustment. In alternative, not shown exemplary embodiments, this can also be achieved by separate proportional valves or variable orifices in the area of the pumps 40, 42.

At the target point, a valve not shown in detail in feed line 28 is opened. Now the pig 52 on the right side in FIG. 4 is kept in a constant position by correspondingly closing the supply line 2 on the right side in FIG. 4, for example by a valve not shown in detail. The pump 40 is actuated by the control unit so that the interspace 54 is compressed. In this way, the paint is transported into the feed line 18. The thereby introduced volume of pushing medium measured at the flow-measuring cell thereby corresponds to the volume of paint introduced into the feed line 18.

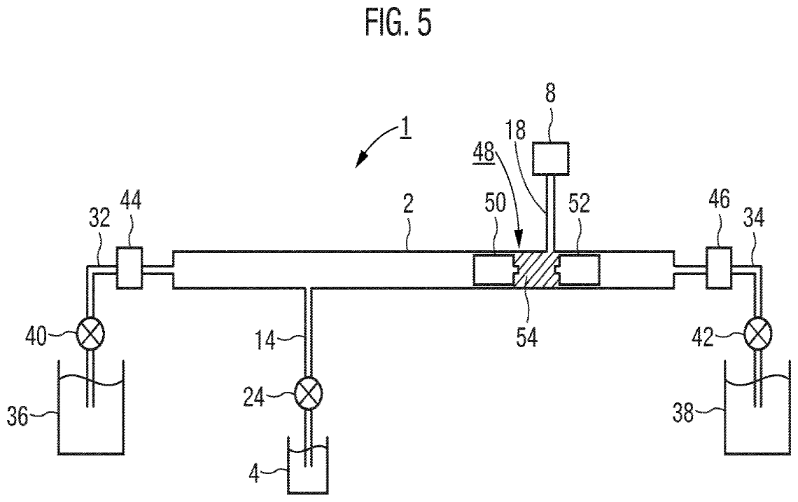

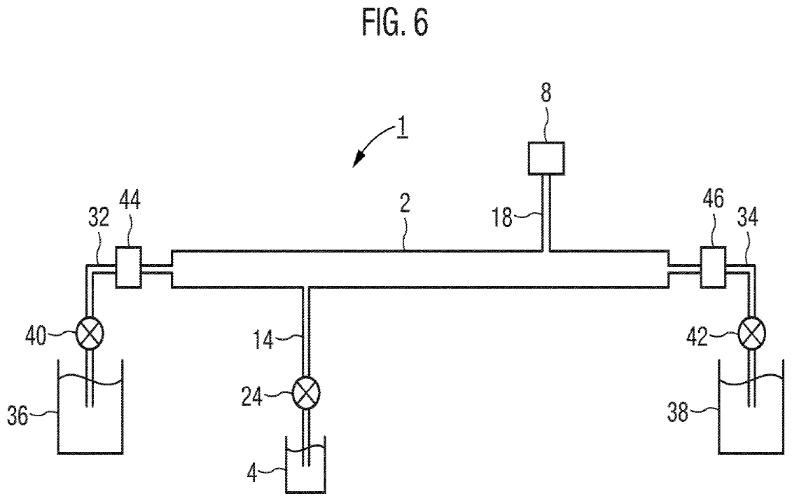

Lastly, FIG. 5 shows the situation after the required quantity has been fed into the point of consumption 8. The quantity of paint in the interspace 54 is reduced accordingly. Now the valve, which is not shown in detail, in feed line 18 is closed. Subsequently, the pig package 48 with the paint still contained in it can be fed to the other points of consumption 10, 12, which are not shown in FIGS. 2 to 5. The positioning and determination of the position of the pig package 48 as well as the determination of the volume of paint in the pig package 48 is carried out as described above.

### REFERENCE SIGN LIST

1 System
2 Supply line
4, 6 Paint reservoir
8, 10
12 Point of consumption
14, 16,
18, 20,
22 Feed line
24, 26 Pump
28, 30 Pig station
32, 34 Pushing medium feed line
36, 38 Pushing medium reservoir
40, 42 Pump
44, 46 Flow-measuring cell
48 Pig package
50, 52 Pig
54 Interspace

1. A method for conveying a working medium within a supply line (2), wherein a pig package (48) is moved into the supply line (2) by means of a pushing medium conveyed by a first pump (40) to a proximal end of the supply line (2), wherein
a first conveying quantity of the pushing medium is determined by means of a first flow-measuring cell (44) associated with the proximal end, and wherein a position of the pig package (48) in the supply line (2) is determined from the first conveying quantity and information about the cross-section of the supply line (2).

2. The method according to claim 1, in which a targeted change in position of the pig package (48) is effected by controlling the first pump (40).

3. The method according to claim 1, wherein the pig package (48) consists of at least two pigs (50, 52), wherein by means of a feed line (14, 18) leading to the interspace (54) between two pigs and arranged on the supply line (2), the working medium is introduced into the interspace (54) or discharged therefrom, wherein the supply line (2) is filled with pushing medium on both sides of the pig package (48), wherein a second conveying quantity of the pushing medium is determined by means of a second flow-measuring cell (46) associated with a distal end of the supply line (2), and wherein a volume of the working medium introduced into the interspace (54) or discharged therefrom is determined from the first and second conveying quantity and information about the cross-section of the supply line (2).

4. The method according to claim 3, in which a pushing medium is conveyed into the distal end of the supply line (2) by a second pump (42).

5. The method according to claim 4, in which a targeted change in position of the pig package (48) is effected by controlling the second pump (42).

6. The method according to any of claim 3, in which by controlling the first and/or the second pump (40, 42) a change in position of the pig package (48) is effected in such a way that the feed line (14, 18) opens into the interspace (54).

7. The method according to claim 2, in which the change in position is effected with variable speed.

8. The method according to claim 1, in which the working medium is a coating material.

9. A control device for a system (1) for conveying a working medium within a supply line (2), designed to carry out the method according to claim 1.

10. A system (1) comprising a supply line, a first pump, (40) associated with a proximal end of the supply line (2), for a pushing medium for moving a pig package (48) into the supply line (2),
further comprising a flow-measuring cell (44) associated with the proximal end, designed to determine a first conveying quantity of the pushing medium, and a control device designed to determine a position of the pig package (48) in the supply line (2) from the first conveying quantity and information about the cross-section of the supply line (2).

11. The system (1) according to claim 10, in which the control device is further designed to effect a targeted change in position of the pig package (48) by controlling the first pump (40).

12. The system (1) according to claim 10, wherein the pig package (48) consists of at least two pigs (50, 52), wherein on the supply line (2) there is a feed line (14, 18) for introducing or discharging the working medium into the interspace (54) between the two pigs (50, 52), wherein the supply line (2) is filled with pushing medium on both sides of the pig package (48), further comprising a second flow-measuring cell (46) associated with the distal end, designed to determine a second conveying quantity of the pushing medium, the control device being further designed to determine a volume of the working medium introduced into the interspace (54) or discharged therefrom from the first and second conveying quantity and information about the cross-section of the supply line (2).

13. The system (1) according to claim 12, further comprising a second pump (42) associated with the distal end of the supply line (2) for conveying pushing medium into the distal end of the supply line (2).

14. The system (1) according to claim 13, in which the control device is further designed to effect a targeted change in position of the pig package (48) by controlling the second pump (42).

15. The system (1) according to claim 12, in which the control device is further designed to effect a change in the position of the pig package (48) by controlling the first and/or the second pump (40, 42) in such a way that the feed line (14, 18) opens into the interspace (54).

16. The system (1) according to claim 11, comprising a flow control device, associated with the proximal and/or the distal end of the supply line (2), for the pushing medium for varying the speed of the position change.

17. The system (1) according to claim 9, in which the working medium is a coating material.
